(19) United States
(12) Patent Application Publication
(10) Pub. No.: US 2014/0248877 A1
(43) Pub. Date: Sep. 4, 2014

(54) METHOD AND APPARATUS FOR AVOIDING INTERFERENCE DUE TO IN-DEVICE COEXISTENCE

(71) Applicant: LG ELECTRONICS NC., Seoul (KR)

(72) Inventors: Jae Wook Lee, Anyang-si (KR); Sung Jun Park, Anyang-si (KR); Sung Hoon Jung, Anyang-si (KR); Young Dae Lee, Anyang-si (KR); Seung June Yi, Anyang-si (KR)

(21) Appl. No.: 14/119,377

(22) PCT Filed: Sep. 24, 2012
(86) PCT No.: PCT/KR2012/007626

§ 371 Date: Nov. 21, 2013

Related U.S. Application Data
(60) Provisional application No. 61/538,931, filed on Sep. 25, 2011.

(51) Int. Cl. H04W 36/00

(52) U.S. Cl. CPC H04W 36/0072
USPC 455/436

(57) ABSTRACT

A method and apparatus for avoiding interference due to in-device coexistence (IDC) are provided. A base station receives a measurement report that indicates IDC problems experienced by a wireless device. The measurement report includes information about at least one interfered frequency on which the wireless device is experiencing the IDC problems that the wireless device cannot solve by itself. The base station transmits to a target base station a handover request that includes information about the at least one interfered frequency.

### TECHNICAL FIELD

The present invention relates to wireless communications, and more particularly, to a method and apparatus for avoiding interference due to in-device coexistence in a wireless communication system.

### BACKGROUND ART

3rd generation partnership project (3GPP) long term evolution (LTE) is an improved version of a universal mobile telecommunication system (UMTS) and is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

In order to allow users to access various networks and services ubiquitously, an increasing number of user equipments (UEs) are equipped with multiple radio transceivers. For example, a UE may be equipped with LTE, WiFi, and Bluetooth transceivers, and Global Navigation Satellite System (GNSS) receivers. One resulting challenge lies in trying to avoid coexistence interference between those collocated radio transceivers.

Due to extreme proximity of multiple radio transceivers within the same UE, the transmit power of one transmitter may be much higher than the received power level of another receiver. This is referred to as interference due to in-device coexistence (IDC) problem. By means of filter technologies and sufficient frequency separation, the transmit signal may not result in significant interference. But for some coexistence scenarios, e.g. different radio technologies within the same UE operating on adjacent frequencies, current filter technology might not provide sufficient rejection.

Therefore, a method for solving the interference problem due to multiple radio transceivers needs to be considered.

### DISCLOSURE OF INVENTION

### Technical Problem

The present invention provides a method and apparatus for avoiding interference due to in-device coexistence in a wireless communication system.

### Solution to Problem

In an aspect, a method for avoiding interference due to in-device coexistence (IDC) in a wireless communication system is provided. The method includes receiving, from a wireless device, a measurement report that indicates IDC problems experienced by the wireless device, the measurement report including information about at least one interfered frequency on which the wireless device is experiencing the IDC problems that the wireless device cannot solve by itself, and transmitting, to a target base station, a handover request during handover preparation, the handover request including information about the at least one interfered frequency.

The method may further include receiving, from the target base station, a handover acknowledgement to perform a handover.

The method may further include transmitting, to the wireless device, a handover command in order to instruct the wireless device to perform the handover from the source base station to the target base station.

The method may further include transmitting, to the wireless device, a measurement configuration that configures the at least one interfered frequency as a measurement object.

In another aspect, a base station configured for avoiding interference due to in-device coexistence (IDC) in a wireless communication system is provided. The base station includes a radio frequency unit configured to receive and transmit a radio signal, and a processor, operably coupled with the radio frequency unit, configured to receive, from a wireless device, a measurement report that indicates IDC problems experienced by the wireless device, the measurement report including information about at least one interfered frequency on which the wireless device is experiencing the IDC problems that the wireless device cannot solve by itself, and transmit, to a target base station, a handover request during handover preparation, the handover request including information about the at least one interfered frequency.

### Advantageous Effects of Invention

A target base station knows an interfered frequency on which the wireless device is experiencing IDC problems during handover preparation. By preventing from performing handover at the interfered frequency, interference due to IDC can be mitigated.

### BRIEF DESCRIPTION OF DRAWINGS

FIG. 1 shows a wireless communication system to which the present invention is applied.

FIG. 2 is a diagram showing a radio protocol architecture for a user plane.

FIG. 3 is a diagram showing a radio protocol architecture for a control plane.

FIG. 4 shows an example of coexistence interference within the same UE.

FIG. 5 shows 3GPP frequency bands around ISM band.

FIG. 6 shows a method for avoiding interference according to an embodiment of the present invention.

FIG. 7 is a block diagram showing a wireless communication system to implement the embodiments of the present invention.

### MODE FOR THE INVENTION

A wireless device may be fixed or mobile, and may be referred to as another terminology, such as a user equipment (UE), a mobile station (MS), a user terminal (UT), a subscriber station (SS), a mobile terminal (MT), etc. A base station may be generally a fixed station that communicates with the wireless device and may be referred to as another terminology, such as an evolved node-B (eNB), a base transceiver system (BTS), an access point, etc.

Multiple radio receivers/transmitters which support multiple radio access technologies (RATs) may be arranged in a single wireless device. RATs may include 3rd Generation Partnership Project (3GPP) Long Term Evolution (LTE)/LTE-Advanced (LTE-A), 3GPP2, WiFi based on Electrical and Electronics Engineers (IEEE) 802.11 standards, WiMAX based on IEEE 802.16 standards, Bluetooth, Global Navigation Satellite System (GNSS), etc. Hereinafter, LTE includes LTE and/or LTE-A. Embodiments are not limited in this context.

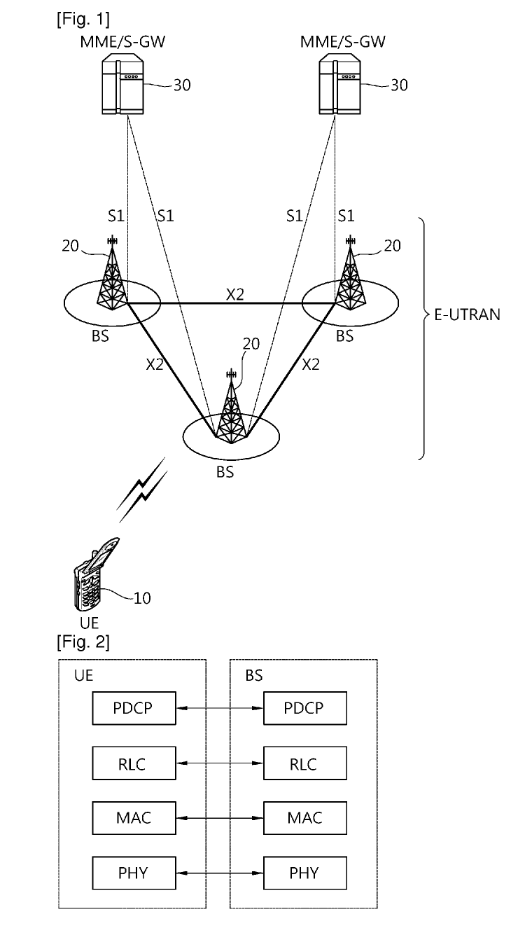

FIG. 1 shows a wireless communication system to which the present invention is applied. The wireless communication system may also be referred to as an evolved-UMTS terrestrial radio access network (E-UTRAN) or a LTE system.

The E-UTRAN includes at least one base station (BS) 20 which provides a control plane and a user plane to a user equipment (UE) 10. The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

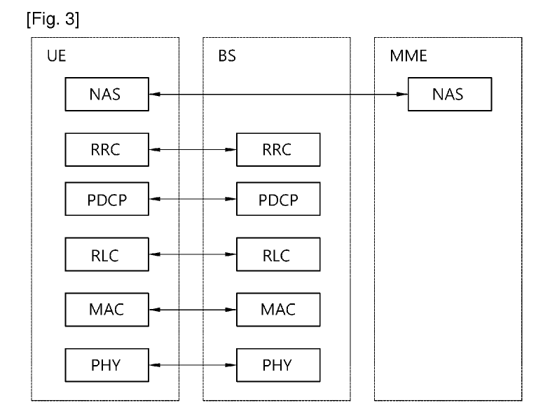

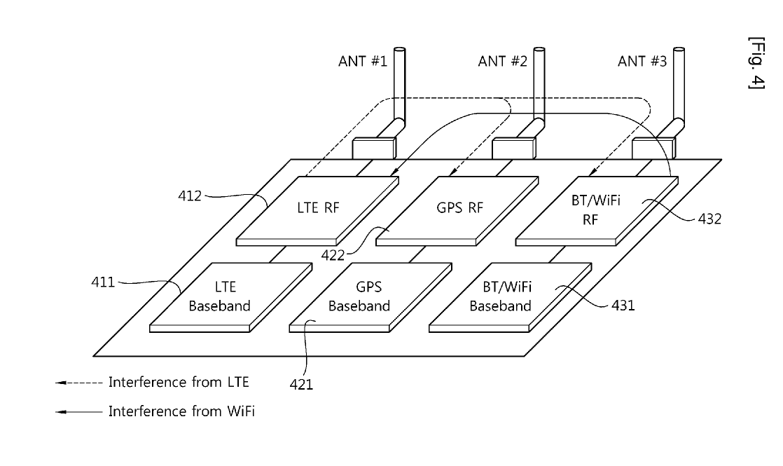

FIG. 2 is a diagram showing a radio protocol architecture for a user plane. FIG. 3 is a diagram showing a radio protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Between different PHY layers, i.e., a PHY layer of a transmitter and a PHY layer of a receiver, data is transferred through the physical channel. The physical channel may be modulated using an orthogonal frequency division multiplexing (OFDM) scheme, and may utilize time and frequency as a radio resource.

Functions of the MAC layer include mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

Functions of the RLC layer include RLC SDU concatenation, segmentation, and re-assembly. To ensure a variety of quality of service (QoS) required by a radio bearer (RB), the RLC layer provides three operation modes, i.e., a transparent mode (TM), an unacknowledged mode (UM), and an acknowledged mode (AM). The UM RLC receives SDUs from the higher layers and segments the SDUs into appropriate RLC PDUs without adding any overhead. The AM RLC provides retransmission by using an automatic repeat request (ARQ). The UM RLC does not provide retransmission.

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., the PHY layer) and the second layer (i.e., the MAC layer, the RLC layer, and the PDCP layer) for data delivery between the UE and the network.

The setup of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the network, the UE is in an RRC connected state (also may be referred to as an RRC connected mode), and otherwise the UE is in an RRC idle state (also may be referred to as an RRC idle mode).

Data is transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several subcarriers in a frequency domain. One subframe includes a plurality of OFDM symbols in the time domain. A resource block is a resource allocation unit, and includes a plurality of OFDM symbols and a plurality of subcarriers. Further, each subframe may use particular subcarriers of particular OFDM symbols (e.g., a first OFDM symbol) of a corresponding subframe for a physical downlink control channel (PDCCH), i.e., an L1/L2 control channel. A transmission time interval (TTI) is a unit time of subframe transmission.

Hereinafter, an RRC state of a UE and an RRC connection mechanism will be described.

The RRC state indicates whether an RRC layer of the UE is logically connected to an RRC layer of an E-UTRAN. If the two layers are connected to each other, it is called an RRC connected state, and if the two layers are not connected to each other, it is called an RRC idle state. When in the RRC connected state, the UE has an RRC connection and thus the E-UTRAN can recognize a presence of the UE in a cell unit. Accordingly, the UE can be effectively controlled. On the other hand, when in the RRC idle state, the UE cannot be recognized by the E-UTRAN, and is managed by a core network in a tracking area unit which is a unit of a wider area than a cell. That is, regarding the UE in the RRC idle state, only a presence or absence of the UE is recognized in a wide area unit. To get a typical mobile communication service such as voice or data, a transition to the RRC connected state is necessary.

When a user initially powers on the UE, the UE first searches for a proper cell and thereafter stays in the RRC idle state in the cell. Only when there is a need to establish an RRC connection, the UE staying in the RRC idle state establishes the RRC connection with the E-UTRAN through an RRC connection procedure and then transitions to the RRC connected state. Examples of a case where the UE in the RRC idle state needs to establish the RRC connection are various, such as a case where uplink data transmission is necessary due to telephony attempt of the user or the like or a case where a response message is transmitted in response to a paging message received from the E-UTRAN.

Hereinafter, in-device coexistence (IDC) problem will be described.

In order to allow users to access various networks and services ubiquitously, an increasing number of UEs are equipped with multiple radio transceivers. For example, a UE may be equipped with LTE, WiFi, Bluetooth transceivers, and GNSS receivers. One resulting challenge lies in trying to avoid coexistence interference between those collocated radio transceivers.

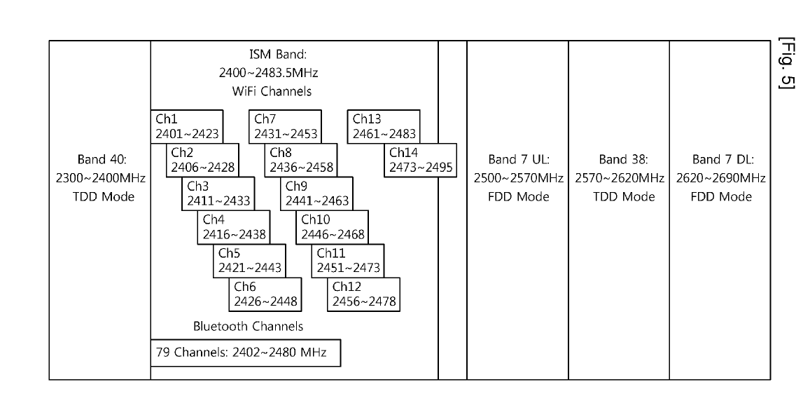

FIG. 4 shows an example of coexistence interference within the same UE.

A LTE module 410 includes a LTE baseband 411 and a LTE radio frequency (RF) 412. A GNSS module 420 includes a GNSS baseband 421 and a GNSS RF 422. A WiFi module 430 includes a WiFi baseband 431 and a WiFi RF 432.

Due to extreme proximity of multiple radio transceivers within the same UE, the transmit power of one transmitter may be much higher than the received power level of another receiver. Accordingly, different RATs within the same UE operating on adjacent frequencies causes interference to each other. For example, if all of the LTE module 410, the GNSS module 420 and the WiFi module 430 are switched on, the LTE module 410 may interfere the GNSS module 420 and the WiFi module 430. Or the WiFi module 430 may interfere the LTE module 410.

The LTE module 410 can measure the IDC interference by cooperating with other radio modules or by inter/intra frequency measurements.

Coexistence scenarios are due to adjacent frequencies between different radio technologies. To describe coexistence interference scenarios between LTE radio and other radio technologies, 3GPP frequency bands around 2.4 GHz Industrial, scientific and medical (ISM) bands are considered.

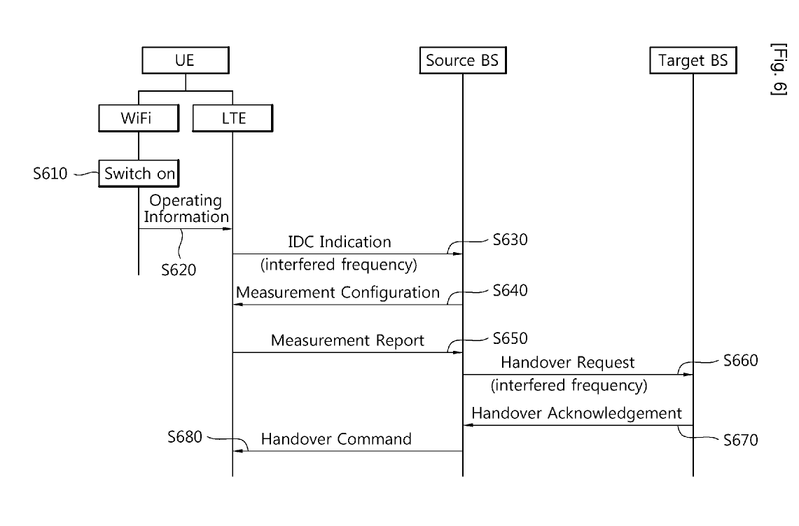

FIG. 5 shows 3GPP frequency bands around ISM band.

The transmitter of LTE band 40 may affect receiver of WiFi and vice-versa. Since band 7 is a FDD band so there is no impact on LTE receiver from WiFi transmitter but WiFi receiver will be affected by LTE uplink transmitter.

Bluetooth operates in 79 channels of 1 MHz each in ISM band. The first channel starts with 2402 MHz and the last channel ends at 2480 MHz. Similar as WiFi case, the activities of LTE band 40 and Bluetooth may disturb each other, and the transmission of LTE band 7 UL may affect Bluetooth reception as well.

The transmitter of LTE band 7/13/14 may cause interference to the receiver of GNSS at 1575.42 MHz.

From the viewpoint of a UE, three modes are considered to avoid interference. First, in an uncoordinated mode, different radio technologies within the same UE operate independently without any internal coordination between each other. Second, in a UE-coordinated mode, there is an internal coordination between the different radio technologies within the same UE, which means that at least the activities of one radio is known by other radio. However, the network is not aware of the coexistence issue possibly experienced by the UE and is therefore not involved in the coordination. Third, in a network-coordinated mode, different radio technologies within the UE are aware of possible coexistence problems and the UE can inform the network about such problems. It is then mainly up to the network to decide how to avoid coexistence interference.

3GPP considers two schemes to solve the IDC problem. According to Frequency Division Multiplexing (FDM) scheme, the interfering module or the interfered module changes its operating frequency. According to Time Division Multiplexing (TDM) scheme, the interfering module and the interfered module use different time.

Interference avoidance due to IDC under discussion does not consider a handover. After completing a handover from a source BS to a target BS, the target BS does not know whether the UE experiences IDC problems until the UE reports the IDC problems to the target BS. The target BS may assign to the UE a frequency on which the UE is experiencing the IDC problems. This may cause excessive delay of service and low QoS.

It is proposed that the source BS informs the target BS of information related to UE's IDC problems.

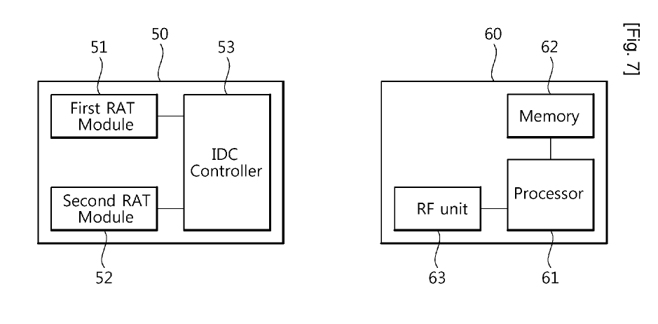

FIG. 6 shows a method for avoiding interference according to an embodiment of the present invention. In this exemplary embodiment, it is assumed that LTE coexists with WiFi and a UE includes two RAT modules: WiFi module and LTE module. Embodiments are not limited to types of RAT and a number of RAT modules.

In step S610, a WiFi module of a UE is switched on.

In step S620, the WiFi module sends operating information to the LTE module via an internal connection. The operating information may be used for the LTE module to check IDC interference. The operating information may include information about an operating frequency, a transmit power, a transmit/receive time.

In step S630, when the UE experiences IDC problems that the UE cannot solve by itself, the UE sends an IDC indication message to the source BS. The IDC indication message may include information about at least one interfered frequency on which the UE is experiencing the IDC problems.

The interfered frequency may include a carrier frequency on which a first RAT module (e.g. WiFi module) causes interference to a second RAT module (e.g. LTE module). The interfered frequency may include an E-UTRA carrier frequency on which the LTE module causes interference to other RAT module or interfered from the other RAT module. The interfered frequency may also be referred as an interfering frequency, an unusable frequency, an IDC frequency, etc.

In step S640, the source BS sends a measurement configuration to the UE. The measurement configuration may include information about at least one measurement object. A measurement object indicates a carrier frequency for which measurement is performed by the UE. The source BS may configure the interfered frequency as the measurement object.

In step S650, after performing measurements, the UE sends a measurement report to the source BS.

In step S660, if the source BS determines a handover to a target BS, the source BS transmits a handover request to the target BS during handover preparation. The handover request may be transmitted via X2 interface or S1 interface. The handover request may include information about the interfered frequency. The handover request may include a field indicating that a corresponding measurement object has IDC problems.

According to the present invention, it is proposed that the source BS informs the target BS of information about the interfered frequency. During handover, the interfered frequency may not be selected as a serving frequency.

In step S670, the target BS sends a handover acknowledgement to the source BS in order to indicate an admission of the handover.

In step S680, the source BS sends to the UE a handover command in order to instruct the UE to perform the handover from the source BS to the target BS. Then, the UE attempts to access to the target BS.

FIG. 7 is a block diagram showing a wireless communication system to implement the embodiments of the present invention.

A wireless device 50 includes a first RAT module 51, a second RAT module 52, an IDC controller 53. The first RAT module 51 is a radio transceiver that supports a first RAT. The second RAT module is a radio transceiver that supports a second RAT. The IDC controller 53 checks whether the wireless device 50 is experiencing IDC problems and sent an IDC indication to a base station via one of the first RAT module 51 and the second RAT module 52. The operation of the UE according to the embodiments of FIG. 6 may be implemented by the wireless device 50.

A BS 60 includes a processor 61, a memory 62, and a radio frequency (RF) unit 63. The memory 62 is coupled to the processor 61, and stores a variety of information for driving the processor 61. The RF unit 63 is coupled to the processor 61, and transmits and/or receives a radio signal. The processor 51 implements the proposed functions, procedures, and/or methods. The processor 51 can implement an operation of the source BS according to the embodiments of FIG. 6.

The processor and the module may include application-specific integrated circuit (ASIC), other chipset, logic circuit and/or data processing device. The memory may include read-only memory (ROM), random access memory (RAM), flash memory, memory card, storage medium and/or other storage device. The RF unit may include baseband circuitry to process radio frequency signals. When the embodiments are implemented in software, the techniques described herein can be implemented with modules (e.g., procedures, functions, and so on) that perform the functions described herein. The modules can be stored in memory and executed by processor. The memory can be implemented within the processor or external to the processor in which case those can be communicatively coupled to the processor via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1.-12. (canceled)

13. A method for avoiding interference due to in-device coexistence (IDC) in a wireless communication system, performed by a source base station, the method comprising:
receiving, from a wireless device, an indication that indicates IDC problems experienced by the wireless device, the indication including information about at least one interfered frequency on which the wireless device is experiencing the IDC problems; and
transmitting, to a target base station, during a handover procedure, the information about the at least one interfered frequency.

14. The method of claim 13, further comprising:
transmitting a handover request to the target base station, the handover request including the information about the at least one interfered frequency; and
receiving, from the target base station, a handover acknowledgement to perform a handover.

15. The method of claim 14, further comprising:
transmitting, to the wireless device, a handover command in order to instruct the wireless device to perform the handover from the source base station to the target base station.

16. The method of claim 13, further comprising:
transmitting, to the wireless device, a measurement configuration that configures the at least one interfered frequency as a measurement object.

17. The method of claim 16, further comprising:
receiving, from a wireless device, a measurement result for the at least one interfered frequency.

18. The method of claim 13, wherein the at least one interfered frequency includes at least one Evolved-Universal Terrestrial Radio Access (E-UTRA) carrier frequency.

19. A base station configured for avoiding interference due to in-device coexistence (IDC) in a wireless communication system, the base station comprising:
a radio frequency unit configured to receive and transmit a radio signal; and
a processor, operably coupled with the radio frequency unit, configured to
receive, from a wireless device, an indication that indicates IDC problems experienced by the wireless device, the indication including information about at least one interfered frequency on which the wireless device is experiencing the IDC problems; and
transmit, to a target base station, during a handover procedure, the information about the at least one interfered frequency.

20. The base station of claim 19, wherein the processor is configured to
transmit a handover request to the target base station, the handover request including the information about the at least one interfered frequency; and
receive, from the target base station, a handover acknowledgement to perform a handover.

21. The base station of claim 20, wherein the processor is configured to transmit, to the wireless device, a handover command in order to instruct the wireless device to perform the handover from the source base station to the target base station.

22. The base station of claim 19, wherein the processor is configured to transmit, to the wireless device, a measurement configuration that configures the at least one interfered frequency as a measurement object.

23. The base station of claim 22, wherein the processor is configured to receive, from a wireless device, a measurement result for the at least one interfered frequency.

24. The base station of claim 19, wherein the at least one interfered frequency includes at least one Evolved-Universal Terrestrial Radio Access (E-UTRA) carrier frequency.
